(19) United States
(12) Patent Application Publication
(10) Pub. No.: US 2019/0218417 A1
(43) Pub. Date: Jul. 18, 2019

(54) WATERBORNE AMINO BAKING VARNISH AND METHOD FOR PREPARING THE SAME

(71) Applicant: HEBEI CHENYANG INDUSTRY & TRADE GROUP., LTD, Baoding, Hebei (CN)

(72) Inventors: Zhongyuan Hu, Baoding (CN); Lizhi Dong, Baoding (CN); Cheng Lu, Baoding (CN); Qi Zheng, Baoding (CN); Yandong Qi, Baoding (CN)

(21) Appl. No.: 16/329,438

(22) PCT Filed: Aug. 30, 2017
(86) PCT No.: PCT/CN2017/099629

§ 371 Date: Feb. 28, 2019

(30) Foreign Application Priority Data
Aug. 30, 2016 (CN) 201610761004.0

(51) Int. Cl. C09D 175/06; C09D 7/80; C08K 3/22; C08K 3/34; C08K 5/053; C09D 5/02

(52) U.S. Cl. CPC C09D 175/06; C09D 7/80; C08K 3/22; C09D 163/10; C08K 5/053; C09D 5/027; C08K 3/34

(57) ABSTRACT

The waterborne amino baking varnish is prepared with raw materials in percent by weight comprising: 25-40% of a waterborne polyurethane, 4-5% of a waterborne epoxy resin, 7-10% of a waterborne amino resin, 25-35% of deionized water, 1.5-2.5% of a pH regulator, 0.3-0.5% of a wetting agent, 0.2-0.6% of a defoamer, 0.5-1% of a dispersant, 1-5% of a cosolvent, 10-20% of a pigment and a filler, 2-5% of nano-alumina, 0.3-0.5% of lithium magnesium silicate, 0.3-0.5% of a thickener, and 0.5-0.8% of a leveling agent.

### CROSS-REFERENCE TO RELATED APPLICATIONS

This application is the International Application No. PCT/CN2017/099629 for entry into US national phase with an international filing date of Aug. 30, 2017, designating US, now pending, and claims priority to Chinese Patent Application No. 201610761004.0, filed on Aug. 30, 2016, the contents of which are incorporated herein by reference.

### TECHNICAL FIELD

The present application relates to the technical filed of a coating composition.

### BACKGROUND

The growing modern coatings industry imposes higher and higher requirements on environmental protection. The reduction of the emission of organic solvents not only protects the environment, but also reduces costs, and is more secure for the health and safety of operators.

The existing coatings generally use organic solvents as raw materials. Such coatings not only cause a large amount of organic solvent emissions, but also endanger the health of operators, and have a major hidden danger for environmental safety.

### SUMMARY

In view of the above technical problems, the present application provides a waterborne amino baking varnish and a method for preparing the same. The waterborne amino baking varnish features waterborne, environmental protection, good stability, high hardness, being applicable to multiple coating processes, strong adhesion, fast drying, strong gloss retention, excellent aging resistance, good water resistance, convenient for construction, low cost, non-combustible, non-explosive, pollution-free, low-temperature storage, and non-deterioration. It also has the characteristics of convenient and quick construction, plain and smooth paint film, and good hand feeling.

In order to solve the above technical problems, the following technical solutions are adopted: a waterborne amino baking varnish, which is prepared with raw materials in percent by weight comprising: 25-40% of a waterborne polyurethane, 4-5% of a waterborne epoxy resin, 7-10% of a waterborne amino resin, 25-35% of deionized water, 1.5-2.5% of a pH regulator, 0.3-0.5% of a wetting agent, 0.2-0.6% of a defoamer, 0.5-1% of a dispersant, 1-5% of a cosolvent, 10-20% of a pigment and a filler, 2-5% of nano-alumina, 0.3-0.5% of lithium magnesium silicate, 0.3-0.5% of a thickener, and 0.5-0.8% of a leveling agent. The waterborne amino baking varnish is prepared by mixing and uniformly stirring the raw materials.

Preferably, the waterborne polyurethane is obtained by copolymerizing a waterborne branched polyester resin and glycidyl tertiary carboxylic ester, and the waterborne polyurethane has an acid value of 40 to 50 mgKOH/g.

More preferably, a process for preparing the waterborne polyurethane comprises: adding glycidyl tertiary carboxylic ester to the waterborne branched polyester resin with an acid value of 50-60 mgKOH/g, performing copolymerization at 120-150° C. until an end point acid value reaches 40-50 mgKOH/g, whereby obtaining the waterborne polyurethane.

More preferably, a weight ratio of the waterborne branched polyester resin to glycidyl tertiary carboxylic ester is 8.5-9:1.

Preferably, the waterborne epoxy resin is synthesized by polymerization of a low iodine value fatty acid and an epoxy resin whereby forming a fatty acid-modified epoxy resin having a secondary hydroxyl group, and the fatty acid-modified epoxy resin having the secondary hydroxyl group has an acid value of ≤5 mgKOH/g.

More preferably, a process for preparing the waterborne epoxy resin comprises: polymerizing the low iodine value fatty acid and the epoxy resin at a temperature of 100-120° C. until an end point acid value reaches ≤5 mgKOH/g, whereby forming the fatty acid-modified epoxy resin having the secondary hydroxyl group.

More preferably, a weight ratio of the epoxy resin to the low iodine value fatty acid is 2-2.5:1, and an iodine value of the low iodine value fatty acid is ≤70 g/100 g.

Preferably, the wetting agent is a wetting agent comprising a polyether modified polysiloxane; the defoamer is a defoamer comprising a polyether modified siloxane copolymer containing fumed silica; the dispersant is an anionic compound of a polyether phosphate; the cosolvent is one or two selected from the group consisting of dipropylene glycol methyl ether and ethylene glycol monobutyl ether; the thickener comprises a non-ionic associative polyurethane thickener and an acrylic acid-acrylic ester copolymer alkali swelling thickener; and the leveling agent is a high molecular weight polydimethylsiloxane emulsion.

A method for preparing the waterborne amino baking varnish comprises the following steps:

1) adding the waterborne polyurethane, the deionized water, the pH regulator, the wetting agent, the defoamer according to the proportion to a paint dispenser and stirring;

2) adding the dispersant, the pigment and the filler, lithium magnesium silicate, nano-alumina, and stirring;

3) adding the cosolvent and stirring; and

4) adding the waterborne amino resin, the waterborne epoxy resin, the leveling agent, and the defoamer, and stirring, measuring an initial viscosity, adding the thickener according to the initial viscosity to regulate a viscosity to 80-90 KU which is measured by a Stormer viscometer at 25° C., whereby obtaining the waterborne amino baking varnish.

Preferably, the method for preparing the waterborne amino baking varnish comprises the following steps:

1) respectively adding the waterborne polyurethane, the deionized water, the pH regulator, the wetting agent, and the defoamer according to the proportion to the paint dispensor, and stirring at a velocity of 800-1000 rpm;

2) adding the dispersant, the pigment and filler, lithium magnesium silicate, and nano-alumina and stirring at a velocity of 1000-1200 rpm for 20 min, wherein a grinding fineness is ≤15 μm;

3) adding the cosolvent and stirring at the velocity of 1000-1200 rpm for 10 min; and

4) respectively adding the waterborne amino resin, the waterborne epoxy resin, the leveling agent, and the defoamer and stirring at a velocity of 600-800 rpm, measuring the initial viscosity, adding the thickener according to the initial viscosity to regulate the viscosity to 80-90 KU which is measured by a Stormer viscometer at 25° C., whereby obtaining the waterborne amino baking varnish.

The waterborne amino baking varnish of the present application is widely applicable to tricycles, bicycles, electric vehicles, motorcycles, small electric vehicles, and the like.

The above technical solutions have the following advantages:

(1) The waterborne amino baking varnish of the present application features waterborne, environmental protection, good stability, high hardness, being applicable to multiple coating processes, strong adhesion, fast drying, strong gloss retention, excellent aging resistance, good water resistance, convenient for construction, low cost, non-combustible, non-explosive, pollution-free, low-temperature storage, and non-deterioration. It also has the characteristics of convenient and quick construction, plain and smooth paint film, and good hand feeling.

(2) The waterborne amino baking varnish of the present application adopts the waterborne polyurethane to make the paint film have high hardness, high gloss, and high fullness, as well as good storage stability and water resistance. The tertiary carbon structure in the molecule effectively shields hydrolyzability of esterification sites in the molecular structure of the branched polyester as well as improving the fullness of the paint film, thereby improving the storage stability and water resistance of the product. The technical problem that the existing waterborne amino coating has poor gloss and fullness in practical application when compared with the solvent-based coatings is tackled, and the easy hydrolysis and instability of the molecular structure of the waterborne polyurethane are tackled by modification.

(3) the waterborne amino baking varnish of the present application uses the waterborne epoxy resin, on the premise that the epoxy resin improves the adhesion to the substrate and the flexibility of the paint film, the low iodine value fatty acid is used for modification, the incompatibility of the polyester resin with the epoxy resin when they are mixed and the resulting reduction in gloss and fullness are avoided, ensuring the appearance effect of the paint film. The addition of the low iodine value fatty acid into the molecular structure also effectively improves the hydrophobicity of the paint film.

(4) The waterborne amino baking varnish of the present application is combined with a nano-scale filler, nano-alumina (α-Al₂O₃), which is filled in the paint film, and has obvious improvement in toughness, scratch resistance and impact resistance of the paint film. The particle size is nanometer-scale, and the surface coating layer is added to the water-based topcoat coating system which does not affect the glossiness and fullness of the paint film, and is suitable for the impact of stone sand and the like.

(5) The waterborne amino baking varnish of the present application adopts the method of compounding the waterborne polyurethane and the waterborne epoxy resin to improve the adhesion of the coating to the substrate, the water resistance, and the storage stability on the premise that the appearance demands on high gloss, high fullness, and high hardness are satisfied by users, and the paint film works normally after 240 hrs of water resistance test.

(6) The waterborne amino baking varnish of the present application is used in combination with lithium magnesium silicate and the thickener to solve the problem of poor stability of waterborne varnish, and the waterborne amino baking varnish works normally after heat storage at 50° C. for more than 30 days.

### DETAILED DESCRIPTION OF THE EMBODIMENTS

The present application is described in further details in combination with specific embodiments.

### Example 1

A waterborne amino baking varnish was prepared with raw materials in percent by weight comprising: 25% of a waterborne polyurethane, 5% of a waterborne epoxy resin, 9% of a waterborne amino resin, 35% of deionized water, 2% of a pH regulator, 0.3% of a wetting agent, 0.4% of a defoamer, 0.5% of a dispersant, 2% of a cosolvent, 17.1% of a pigment and a filler, 2% of nano-alumina, 0.5% of lithium magnesium silicate, 0.4% of a thickener, and 0.8% of a leveling agent.

A preparation process of the waterborne polyurethane was conducted as follows: glycidyl tertiary carboxylic ester was added to the waterborne branched polyester resin with an acid value of 50 mgKOH/g, copolymerization was performed at 120° C. for 0.5 hr until an end point acid value reached 40 mgKOH/g, thereby obtaining the waterborne polyurethane. A weight ratio of the waterborne branched polyester resin to glycidyl tertiary carboxylic ester was 8.5:1.

A preparation process of the waterborne epoxy resin was conducted as follows: the low iodine value fatty acid and the epoxy resin were polymerized at a temperature of 120° C. for 2 hrs until an end point acid value reaches 5 mgKOH/g, thereby forming the fatty acid-modified epoxy resin having the secondary hydroxyl group. A weight ratio of the epoxy resin to the low iodine value fatty acid was 2.2:1, and an iodine value of the low iodine value fatty acid is ≤70 g/100 g.

The wetting agent was a wetting agent comprising a polyether modified polysiloxane. The defoamer was a defoamer comprising a polyether modified siloxane copolymer containing fumed silica. The dispersant was an anionic compound of a polyether phosphate. The cosolvent was dipropylene glycol methyl ether. The thickener included a non-ionic associative polyurethane thickener and an acrylic acid-acrylic ester copolymer alkali swelling thickener (a weight ratio of the non-ionic associative polyurethane thickener and the acrylic acid-acrylic ester copolymer alkali swelling thickener was 2:1). The leveling agent was a high molecular weight polydimethylsiloxane emulsion.

The method for preparing the waterborne amino baking varnish included the following steps:

1) the waterborne polyurethane, the deionized water, the pH regulator, the wetting agent, and the defoamer according to the proportion were respectively added to a paint dispensor, and stirred at a velocity of 800-1000 rpm;

2) the dispersant, the pigment and filler, lithium magnesium silicate, and nano-alumina were added and stirred at a velocity of 1000-1200 rpm for 20 min, and a grinding fineness was ≤15 μm;

3) the cosolvent was added and stirred at the velocity of 1000-1200 rpm for 10 min; and

4) the waterborne amino resin, the waterborne epoxy resin, the leveling agent, and the defoamer were respectively added to the paint dispenser and stirred at a velocity of 600-800 rpm, an initial viscosity was then measured. According to the initial viscosity, the thickener was added to regulate the viscosity to 80-90 KU, which was measured by a Stormer viscometer at 25° C., thereby obtaining the waterborne amino baking varnish.

### Example 2

A waterborne amino baking varnish was prepared with raw materials in percent by weight comprising: 30% of a waterborne polyurethane, 4% of a waterborne epoxy resin, 7% of a waterborne amino resin, 28.8% of deionized water, 1.5% of a pH regulator, 0.4% of a wetting agent, 0.2% of a defoamer, 0.7% of a dispersant, 1% of a cosolvent, 20% of a pigment and a filler, 5% of nano-alumina, 0.4% of lithium magnesium silicate, 0.3% of a thickener, and 0.7% of a leveling agent.

A preparation process of the waterborne polyurethane was conducted as follows: glycidyl tertiary carboxylic ester was added to the waterborne branched polyester resin with an acid value of 60 mgKOH/g, copolymerization was performed at 130° C. for 0.5 hr until an end point acid value reached 50 mgKOH/g, thereby obtaining the waterborne polyurethane. A weight ratio of the waterborne branched polyester resin to glycidyl tertiary carboxylic ester was 9:1.

A preparation process of the waterborne epoxy resin was conducted as follows: the low iodine value fatty acid and the epoxy resin were polymerized at a temperature of 100° C. for 3 hrs until an end point acid value reaches 4 mgKOH/g, thereby forming the fatty acid-modified epoxy resin having the secondary hydroxyl group. A weight ratio of the epoxy resin to the low iodine value fatty acid was 2.5:1, and an iodine value of the low iodine value fatty acid is ≤70 g/100 g.

The wetting agent was a wetting agent comprising a polyether modified polysiloxane. The defoamer was a defoamer comprising a polyether modified siloxane copolymer containing fumed silica. The dispersant was an anionic compound of a polyether phosphate. The cosolvent was ethylene glycol monobutyl ether. The thickener included a non-ionic associative polyurethane thickener and an acrylic acid-acrylic ester copolymer alkali swelling thickener (a weight ratio of the non-ionic associative polyurethane thickener and the acrylic acid-acrylic ester copolymer alkali swelling thickener was 2:1). The leveling agent was a high molecular weight polydimethylsiloxane emulsion.

The preparation process of the waterborne amino baking varnish was the same as that of Example 1.

### Example 3

A waterborne amino baking varnish was prepared with raw materials in percent by weight comprising: 35% of a waterborne polyurethane, 4.5% of a waterborne epoxy resin, 10% of a waterborne amino resin, 26% of deionized water, 2.5% of a pH regulator, 0.3% of a wetting agent, 0.5% of a defoamer, 0.8% of a dispersant, 5% of a cosolvent, 11% of a pigment and a filler, 3% of nano-alumina, 0.3% of lithium magnesium silicate, 0.5% of a thickener, and 0.6% of a leveling agent.

A preparation process of the waterborne polyurethane was conducted as follows: glycidyl tertiary carboxylic ester was added to the waterborne branched polyester resin with an acid value of 55 mgKOH/g, copolymerization was performed at 140° C. for 0.5 hr until an end point acid value reached 45 mgKOH/g, thereby obtaining the waterborne polyurethane. A weight ratio of the waterborne branched polyester resin to glycidyl tertiary carboxylic ester was 8.8:1.

A preparation process of the waterborne epoxy resin was conducted as follows: the low iodine value fatty acid and the epoxy resin were polymerized at a temperature of 110° C. for 2.5 hrs until an end point acid value reaches 3 mgKOH/g, thereby forming the fatty acid-modified epoxy resin having the secondary hydroxyl group. A weight ratio of the epoxy resin to the low iodine value fatty acid was 2:1, and an iodine value of the low iodine value fatty acid is ≤70 g/100 g.

The wetting agent was a wetting agent comprising a polyether modified polysiloxane. The defoamer was a defoamer comprising a polyether modified siloxane copolymer containing fumed silica. The dispersant was an anionic compound of a polyether phosphate. The cosolvent was two selected from the group consisting of dipropylene glycol methyl ether and ethylene glycol monobutyl ether (a weight ratio of dipropylene glycol methyl ether to ethylene glycol monobutyl ether was 1:1). The thickener included a non-ionic associative polyurethane thickener and an acrylic acid-acrylic ester copolymer alkali swelling thickener (a weight ratio of the non-ionic associative polyurethane thickener and the acrylic acid-acrylic ester copolymer alkali swelling thickener was 2:1). The leveling agent was a high molecular weight polydimethylsiloxane emulsion.

The preparation process of the waterborne amino baking varnish was the same as that of Example 1.

### Example 4

A waterborne amino baking varnish was prepared with raw materials in percent by weight comprising: 40% of a waterborne polyurethane, 4.9% of a waterborne epoxy resin, 8% of a waterborne amino resin, 25% of deionized water, 1.5% of a pH regulator, 0.5% of a wetting agent, 0.6% of a defoamer, 1% of a dispersant, 3% of a cosolvent, 10% of a pigment and a filler, 4% of nano-alumina, 0.5% of lithium magnesium silicate, 0.5% of a thickener, and 0.5% of a leveling agent.

A preparation process of the waterborne polyurethane was conducted as follows: glycidyl tertiary carboxylic ester was added to the waterborne branched polyester resin with an acid value of 50 mgKOH/g, copolymerization was performed at 150° C. for 0.5 hr until an end point acid value reached 42 mgKOH/g, thereby obtaining the waterborne polyurethane. A weight ratio of the waterborne branched polyester resin to glycidyl tertiary carboxylic ester was 8.7:1.

A preparation process of the waterborne epoxy resin was conducted as follows: the low iodine value fatty acid and the epoxy resin were polymerized at a temperature of 120° C. for 3 hrs until an end point acid value reaches 2 mgKOH/g, thereby forming the fatty acid-modified epoxy resin having the secondary hydroxyl group. A weight ratio of the epoxy resin to the low iodine value fatty acid was 2.4:1, and an iodine value of the low iodine value fatty acid is ≤70 g/100 g.

The wetting agent was a wetting agent comprising a polyether modified polysiloxane. The defoamer was a defoamer comprising a polyether modified siloxane copolymer containing fumed silica. The dispersant was an anionic compound of a polyether phosphate. The cosolvent was dipropylene glycol methyl ether. The thickener included a non-ionic associative polyurethane thickener and an acrylic acid-acrylic ester copolymer alkali swelling thickener (a weight ratio of the non-ionic associative polyurethane thickener and the acrylic acid-acrylic ester copolymer alkali swelling thickener was 2:1). The leveling agent was a high molecular weight polydimethylsiloxane emulsion.

The preparation process of the waterborne amino baking varnish was the same as that of Example 1.

The above waterborne amino baking varnish prepared by the above method of the present application was tested, and the technical indicators were measured as follows:

| | |
|---|---|
| Hardness | ≥2H (pencil hardness test), |
| Gloss | ≥98 (60° angle test), |
| Adhesion | ≤1 level (cross-cut test 1 mm), |
| Stability | ≥30 d (50° C. storage), |
| Water resistance | ≥240 h, and |
| Impact | Level 1 (100 cm). |

The waterborne amino baking varnish of the present application features waterborne, environmental protection, good stability, high hardness, being applicable to multiple coating processes, strong adhesion, fast drying, strong gloss retention, excellent aging resistance, good water resistance, convenient for construction, low cost, non-combustible, non-explosive, pollution-free, low-temperature storage, and non-deterioration. It also has the characteristics of convenient and quick construction, plain and smooth paint film, and good hand feeling.

Although the present invention has been described with reference to preferred embodiments, workers skilled in the art will recognize that changes may be made in form and detail without departing from the spirit and scope of the invention.

1. A waterborne amino baking varnish, prepared with raw materials in percent by weight comprising:
25-40% of a waterborne polyurethane, 4-5% of a waterborne epoxy resin, 7-10% of a waterborne amino resin, 25-35% of deionized water, 1.5-2.5% of a pH regulator, 0.3-0.5% of a wetting agent, 0.2-0.6% of a defoamer, 0.5-1% of a dispersant, 1-5% of a cosolvent, 10-20% of a pigment and a filler, 2-5% of nano-alumina, 0.3-0.5% of lithium magnesium silicate, 0.3-0.5% of a thickener, and 0.5-0.8% of a leveling agent;
wherein the waterborne amino baking varnish is prepared by mixing and uniformly stirring the raw materials; and
wherein the waterborne epoxy resin is synthesized by polymerization of a low iodine value fatty acid and an epoxy resin whereby forming a fatty acid-modified epoxy resin having a secondary hydroxyl group, and the fatty acid-modified epoxy resin having the secondary hydroxyl group has an acid value of ≤5 mgKOH/g.

2. The waterborne amino baking varnish of claim 1, wherein the waterborne polyurethane is obtained by copolymerizing a waterborne branched polyester resin and glycidyl tertiary carboxylic ester, and the waterborne polyurethane has an acid value of 40 to 50 mgKOH/g.

3. The waterborne amino baking varnish of claim 2, wherein a process for preparing the waterborne polyurethane comprises: adding glycidyl tertiary carboxylic ester to the waterborne branched polyester resin with an acid value of 50-60 mgKOH/g, performing copolymerization at 120-150° C. until an end point acid value reaches 40-50 mgKOH/g, whereby obtaining the waterborne polyurethane.

4. The waterborne amino baking varnish of claim 3, wherein a weight ratio of the waterborne branched polyester resin to glycidyl tertiary carboxylic ester is 8.5-9:1.

5. The waterborne amino baking varnish of claim 1, wherein a process for preparing the waterborne epoxy resin comprises: polymerizing the low iodine value fatty acid and the epoxy resin at a temperature of 100-120° C. until an end point acid value reaches ≤5 mgKOH/g, whereby forming the fatty acid-modified epoxy resin having the secondary hydroxyl group.

6. The waterborne amino baking varnish of claim 5, wherein a weight ratio of the epoxy resin to the low iodine value fatty acid is 2-2.5:1, and an iodine value of the low iodine value fatty acid is ≤70 g/100 g.

7. The waterborne amino baking varnish of claim 1, wherein
the wetting agent is a wetting agent comprising a polyether modified polysiloxane;
the defoamer is a defoamer comprising a polyether modified siloxane copolymer containing fumed silica;
the dispersant is an anionic compound of a polyether phosphate;
the cosolvent is one or two selected from the group consisting of dipropylene glycol methyl ether and ethylene glycol monobutyl ether;
the thickener comprises a non-ionic associative polyurethane thickener and an acrylic acid-acrylic ester copolymer alkali swelling thickener; and
the leveling agent is a high molecular weight polydimethylsiloxane emulsion.

8. A method for preparing the waterborne amino baking varnish claim 1, comprising the following steps:
1) adding the waterborne polyurethane, the deionized water, the pH regulator, the wetting agent, the defoamer according to the proportion to a paint dispenser and stirring;
2) adding the dispersant, the pigment and the filler, lithium magnesium silicate, nano-alumina, and stirring;
3) adding the cosolvent and stirring; and
4) adding the waterborne amino resin, the waterborne epoxy resin, the leveling agent, and the defoamer, and stirring, measuring an initial viscosity, adding the thickener according to the initial viscosity to regulate a viscosity to 80-90 KU which is measured by a Stormer viscometer at 25° C., whereby obtaining the waterborne amino baking varnish.

9. The method for preparing the waterborne amino baking varnish of claim 8, comprises the following steps:
1) respectively adding the waterborne polyurethane, the deionized water, the pH regulator, the wetting agent, and the defoamer according to the proportion to the paint dispensor, and stirring at a velocity of 800-1000 rpm;
2) adding the dispersant, the pigment and filler, lithium magnesium silicate, and nano-alumina and stirring at a velocity of 1000-1200 rpm for 20 min, wherein a grinding fineness is ≤15 μm;
3) adding the cosolvent and stirring at the velocity of 1000-1200 rpm for 10 min; and
4) respectively adding the waterborne amino resin, the waterborne epoxy resin, the leveling agent, and the defoamer and stirring at a velocity of 600-800 rpm, measuring the initial viscosity, adding the thickener according to the initial viscosity to regulate the viscosity to 80-90 KU which is measured by the Stormer viscometer at 25° C., whereby obtaining the waterborne amino baking varnish.
